(19) United States
(12) Patent Application Publication
(10) Pub. No.: US 2005/0147080 A1
(43) Pub. Date: Jul. 7, 2005

(54) Radio-controlled clock and method for determining the beginning of a second from a transmitted time signal

(76) Inventors: Horst Haefner, Heilbronn (DE); Roland Polonio, Neckarsulm (DE); Hans-Joachim Sailer, Heilbronn (DE)

Correspondence Address: FASSE PATENT ATTORNEYS, P.A., P.O. BOX 726, HAMPDEN, ME, 04444-0726, US

(21) Appl. No.: 11/027,582

(22) Filed: Dec. 30, 2004

(30) Foreign Application Priority Data
Dec. 30, 2003 (DE) 103 61 593.8

(51) Int. Cl. H04L 12/50

(52) U.S. Cl. 370/350

(57) ABSTRACT

A transmitted time signal carries encoded time information in a succession of time frames of constant duration. An amplitude variation of the time signal indicates the beginning of a second within a time frame, but may be obscured by interference. Once an actual second beginning is known, e.g. unambiguously detected without interference, then a counter counts up a prescribed number of timing pulses of a reference clock signal to calculate the next expected second beginning of the next time frame. If the next actual second beginning is obscured by interference, then the calculated second beginning is used, otherwise the next actual second beginning can be used, in the decoding and evaluation of the time information. The counter is reset and counts up to calculate the successive next expected second beginning. A circuit for performing this method includes a signal form evaluating unit, a counter, a regulating unit and a reference clock signal generator.

### PRIORITY CLAIM

This application is based on and claims the priority under 35 U.S.C. §119 of German Patent Application 103 61 593.8, filed on Dec. 30, 2003, the entire disclosure of which is incorporated herein by reference.

### FIELD OF THE INVENTION

The invention relates to a method for determining the beginning of a second from a transmitted time signal containing time information, as well as a radio-controlled clock and its receiver circuit for carrying out such a method.

### BACKGROUND INFORMATION

It is conventionally known to provide time reference information in time signals that are transmitted by radio transmission from a time signal transmitter. Such a signal may also be called a time marker signal, a time data signal, a time code signal, or a time reference signal, for example, but will simply be called a time signal herein for simplicity. The time signal transmitter obtains the time reference information, for example, from a high precision atomic clock, and broadcasts this highly precise time reference information via the time signal. Thus, any radio-controlled clock receiving the signal can be synchronized or corrected to display the precise time in conformance with the time standard established by the atomic clock that provides the time reference information for the time signal transmitter. The time signal is especially a transmitter signal of short duration, that serves to transmit or broadcast the time reference information provided by the atomic clock or other suitable time reference emitter. In this regard, the time signal is a modulated oscillation generally including plural successive time markers, which each simply represent a pulse when demodulated, whereby these successive time markers represent or reproduce the transmitted time reference with a given uncertainty.

A time signal transmitter as mentioned above is, for example, represented by the official German longwave transmitting station DCF-77, which continuously transmits amplitude-modulated longwave time signals controlled by atomic clocks to provide the official atomic time scale for Central European Time (CET), with a transmitting power of 50 kW at a frequency of 77.5 kHz. In other countries, such as Great Britain, Japan, China, and the United States, for example, similar transmitters transmit time information on carrier waves in a longwave frequency range from 40 kHz to 120 kHz. In all of the above mentioned countries, the time information is transmitted in the time signal by means of a succession of time frames organized in time code telegrams that each have a duration of exactly one minute.

FIG. 1 diagrammatically represents the coding scheme of a time code or time information telegram A that pertains for the encoded time information provided by the German time signal transmitter DCF-77. The coding scheme or telegram in this case consists of 59 bits in 59 time frames, whereby each single bit or time frame corresponds to one second. Thus, the so-called time code telegram A, which especially provides information regarding the correct time and date in binary encoded form, can be transmitted in the course of one minute. The first 15 bits in bit range B comprise a general encoding, which contain operating information, for example. The next 5 bits in bit range C contain general information. Particularly, the general information bits C include an antenna bit R, an announcement bit A1 announcing or indicating the transition from Central European Time (CET) to Central European Summer Time (CEST) and back again, zone time bits Z1 and Z2, an announcement bit A2 announcing or indicating a so-called leap second, and a start bit S of the encoded time information.

From the 21^{st} bit to the 59^{th} bit, the time and date informations are transmitted in a Binary Coded Decimal (BCD) code, whereby the respective data are pertinent for the next subsequent or following minute. In this regard, the bits in the range D contain information regarding the minute, the bits in the range E contain information regarding the hour, the bits in the range F contain information regarding the calendar day or date, the bits in the range G contain information regarding the day of the week, the bits in the range H contain information regarding the calendar month, and the bits in the range I contain information regarding the calendar year. These informations are present bit-by-bit in encoded form. Furthermore, so-called test or check bits P1, P2, P3 are additionally provided respectively at the ends of the bit ranges D, E and I. The 60^{th} bit or time frame of the time code telegram A is not occupied, i.e. is “blank” and serves to indicate the beginning of the next telegram A. Namely, the minute marker M following the blank interval represents the beginning of the next time code telegram A.

The structure and the bit occupancy of the encoding scheme or telegram A shown in FIG. 1 for the transmission of time signals is generally known, and is described, for example, in an article by Peter Hetzel entitled “Zeitinformation und Normalfrequenz” (“Time Information and Normal Frequency”), published in Telekom Praxis, Vol. 1, 1993.

The transmission of the time marker or code information is performed by amplitude modulating a carrier frequency with the individual second markers. More particularly, the modulation comprises a dip or lowering or reduction X1, X2 (or alternatively an increase or raising) of the carrier signal X at the beginning of each second, except for the 59^{th} second of each minute, when the signal is omitted or blank as mentioned above. In this regard, in the case of the time signal transmitted by the German transmitter DCF-77, the carrier amplitude of the signal is reduced, to about 25% of the normal amplitude, at the beginning of each second for a duration X1 of 0.1 seconds or for a duration X2 of 0.2 seconds, for example as shown in present FIG. 2.

These amplitude reductions or dips X1, X2 of differing duration respectively define second markers or data bits in decoded form. The differing time durations of the second markers serve for the binary encoding of the time of day and the date, whereby the second markers X1 with a duration of 0.1 seconds correspond to the binary “0” and the second markers X2 with the duration of 0.2 seconds correspond to the binary “1”. Thus the modulation represents a binary pulse duration modulation. As mentioned above, the absence of the 60^{th} second marker announces the next following minute marker.

Thus, in combination with the respective second, it is then possible to evaluate the time information transmitted by the time signal transmitter. FIG. 2 shows a portion of an example of such an amplitude modulated time signal as discussed above, in which the encoding is achieved by respective temporary reductions or dips of the amplitude of the HF signal having different pulse durations. Note that the total duration of each time frame from the beginning of one dip to the beginning of the next dip or second marker X1 or X2 amounts to 1000 ms or 1 second, while the individual dips or amplitude reductions acting as second markers X1 and X2 respectively have individual durations of 100 ms or 200 ms, i.e. 0.1 seconds or 0.2 seconds, as described above for the German transmitter DCF-77.

This evaluation of the exact time and the exact date is, however, only possible if the fifty-nine second bits of a minute are unambiguously recognized, and thus correspondingly, it is possible to unambiguously allocate either a “0” or a “1” to each of the second markers represented by the second bits of the signal. In this regard it is problematic that the received time signals can be obscured or falsified by interference signals superimposed thereon. Such interference signals arise from the interference fields emitted by electrical or electronic devices, for example in the direct surrounding vicinity of the time signal receiver. Depending on the type, scope and strength of these interference signals, the reception of the time signal will be more or less interfered with, and it may become impossible to correctly recognize and evaluate the second markers of the signal.

The general technical background of radio-controlled clocks and receiver circuits for receiving time signals as generally discussed above are disclosed in the German Patent Publications DE 198 08 431 A1, DE 43 19 946 A1, DE 43 04 321 C2, DE 42 37 112 A1, and DE 42 33 126 A1. Furthermore, the methods and techniques for acquiring and processing the time information from transmitted time signals are disclosed in Patent Publications DE 195 14 031 C2, DE 37 33 965 C2, and EP 0,042,913 B1. A method for determining the beginning of a second is described in the German Patent Publication DE 195 14 036 C2, as will be discussed in further detail below.

In order to achieve a very good evaluation of the second markers, or particularly the corresponding duration of the dip of the signal amplitude, it is essential to have the most exact possible information regarding the true beginning respectively of these second markers or amplitude dips. The beginning of such an amplitude dip, i.e. the beginning of a second, is also simply called a “second beginning” in this application.

The German Patent Publication DE 37 33 965 C2 discloses a method for acquiring information from disturbed (i.e. interference burdened) data of a time signal transmitter. In this conventional method, the signal provided by the receiver is sampled at a prescribed frequency. In a time interval of a time frame (i.e. a second), the sampled values at the corresponding time points are added up, so that an average signal course or progression is formed after a certain time. Further in this regard, a correlation between the average signal acquired from several second courses or signal progressions and a model signal is used for determining the second beginning, i.e. the beginning of a respective second. The conventional method according to DE 37 33 965 C2 suffers a significant disadvantage, however, in that a signal acquired from the signal courses or progressions of several time frames must be compared with a model signal in order to achieve the synchronization of the radio-controlled clock to the second beginning. The preparation of the model signal in the form of a table or a calculation rule necessarily requires that an additional memory and/or additional calculation capacity must be provided. Moreover, carrying out the comparison as mentioned above also requires an extremely high expenditure of computational time and effort.

In comparison to the above described conventional method, the German Patent Publication DE 195 14 036 C2 discloses a further developed, improved method for determining the second beginning in a time signal. Also in this further conventional method, the time signals transmitted by the time signal transmitter and received by the receiver of the radio-controlled clock are sampled over several time frames, i.e. several seconds. The sampled values of the time signal are also stored in a memory arrangement provided for this purpose. In order to determine the second beginning, an average signal course or progression is determined from the stored sampled values, whereby the minimum of the average signal course is valued or taken as the beginning of the second marker dip of the signal amplitude and thus as the second beginning.

Thus, in both of the above described conventional methods for determining the second beginning, respectively the received time signal is sampled and evaluated, and the second beginning is derived from the evaluated sampled values. Such conventional methods are very reliable, but only so long as the time signal actually received by the receiver of the radio-controlled clock corresponds with the true time signal that has been transmitted by the transmitter. However, such correspondence of the received time signal with the transmitted time signal occurs relatively seldom or infrequently in actual practice. In reality, the transmitted time signal is more or less strongly superimposed and thus obscured or falsified by interference signals by the time the signal is received, decoded and evaluated by the radio-controlled clock. These interference signals, which typically arise in the transmission path between the time signal transmitter and the radio-controlled clock receiver, and also within the receiver section of the radio-controlled clock itself, can occasionally very strongly or sharply change and thus falsify the signal form of the transmitted time signal.

This interference problem can even go so far, that at the actual second beginning, the received time signal has such a strong interference pulse superimposed thereon, that the actual second beginning can no longer be correctly determined or derived from the sampled signal curve course or progression of the signal amplitude. Thus, in such a situation, the above described conventional methods for determining the second beginning will determine a second beginning that is offset or time-shifted after or even before the actual second beginning occasionally it can also arise, that the time signal is superimposed with such a strong interference pulse during the duration of an amplitude dip (i.e. representing a second marker), such that the second beginning of the current time frame cannot be detected at all, which ultimately leads to the result that the corresponding data bit cannot be decoded at all.

In disadvantageous cases it can also arise that the corresponding data bit is erroneously decoded and evaluated due to the time offset or time shifting of the second beginning that has been determined from the sampled values. For example, the detected second beginning could become so far time-shifted from the actual second beginning, so that an actual amplitude dip having a duration of 200 milliseconds to represent a logic “1” is erroneously detected as an amplitude dip having a duration of only 100 milliseconds to represent a logic “0”. This can directly lead to a determination and indication of an incorrect time.

### SUMMARY OF THE INVENTION

In view of the above, it is an object of the invention to provide an improved, and especially more reliable, method for determining the beginning of a second from a time signal received by the receiver section of a radio-controlled clock. Further objects of the invention are to provide such a method that is simple and economical to carry out, and to provide a simple economical receiver circuit arrangement for carrying out such a method. The invention further aims to avoid or overcome the disadvantages of the prior art, and to achieve additional advantages, as apparent from the present specification. The attainment of these objects is, however, not a required limitation of the claimed invention. The above objects have been achieved according to the invention in a method of processing a transmitted time signal, comprising the steps:
a) receiving a time signal that has been transmitted from a time signal transmitter, wherein the time signal comprises a succession of time frames that each respectively have a constant duration and that encode time information, and wherein respective amplitude variations of an amplitude of the time signal indicate respective actual second beginnings of respective second markers of the time information respectively within the time frames;
b) providing a reference clock signal comprising a succession of reference timing pulses;
c) obtaining a known actual second beginning among the actual second beginnings, for a given time frame among the time frames; and
d) determining a calculated second beginning for a subsequent time frame among the time frames temporally following the given time frame by counting a prescribed number of the reference timing pulses of the reference clock signal starting from the known actual second beginning.

The above objects have further been achieved according to the invention in a circuit arrangement for a radio-controlled clock for receiving and acquiring time information from a time signal that is transmitted by a time signal transmitter and that has the time information encoded in successive time frames therein, the circuit arrangement comprising:
a receiver unit adapted to receive the time signal; and
a time synchronization circuit connected to an output of the receiver circuit and adapted to determine a beginning of a second in one of the time frames by counting reference timing pulses of a reference clock signal starting from an already known second beginning of a previous one of the time frames.

The present invention is generally based on the recognition that the transmitted time signal consists of a plurality of time frames each having a constant time duration. Beginning from that point, the basic idea of the present invention is that it is not absolutely necessary to determine the corresponding second beginning for each time frame through evaluating the sampled values or through detecting a change in the amplitude course of the time signal. Rather, for determining the respective second beginnings of successive time frames, it is only necessary to determine an actual second beginning once, i.e. for one time frame. Once a single actual second beginning is known, the further successive second beginnings can be easily determined, i.e. calculated, simply by adding up the known time duration of a time frame or a multiple thereof beginning from the first known second beginning to determine the successive second beginnings of the subsequent time frames. A special advantage of the inventive method is thus that it is no longer necessary to use the actual received time signal, which might be obscured or falsified with an interference signal, for determining the successive second beginnings.

The determination of the time duration of a time frame is advantageously carried out using a counter. A first change or variation of the time signal starts this counter, which is clocked and thus incremented by a prescribed constant reference clock signal, i.e. timing pulse signal. If another change or variation, e.g. particularly a reduction or dip, of the signal amplitude occurs after the known time duration that approximately corresponds to the duration of a time frame, then this next amplitude dip is valued as a new actual second beginning. Once this actual second beginning has been determined, then the respective subsequent second beginnings of the successive time frames are determined after this time point from the counter value of the counter.

The above cycle for determining an actual second beginning can be repeated and the counter can be reset every time a valid actual second beginning (without interference) is detected at the expected time. Moreover, in successive cycles, the counter can be reset at each second beginning and then restarted to be incremented by the clock or timing pulse signal. The counter then generates a start pulse respectively after the duration of a time frame, whereby this start pulse indicates the calculated or timed second beginning of the next successive time frame. Then, the decoding and evaluation of the time information contained in the received time signal begins at the time point of the second beginning that has been calculated by the counter value of the counter. Thus, any interference that may be superimposed on the received time signal no longer has such a serious influence on the determination of the second beginning as would otherwise be the case in conventional methods and circuit arrangements. According to the invention, the respective second beginning of successive time frames can also be determined for a received time signal that is more or less strongly obscured or falsified by interference.

The inventive circuit arrangement for determining the second beginning can be achieved with very simple circuit means, because the counter that is necessarily present in the circuit anyway for evaluating and decoding a change or variation of the amplitude of the time signal can simply be used not only for the evaluation of the corresponding time information, but also for the determination of the respective beginnings of the second pulses according to the invention as described herein.

Very often, however, the calculated or timed second beginning does not exactly correspond to the actual second beginning, so that a small time offset or time shift of the calculated second beginning relative to the actual second beginning in the time signal can occur. Through addition of these time shifts or time offsets over several successive time frames, it can thus arise that the calculated second beginning becomes ever further time-shifted from the actual second beginning. The cause for such time-shifts is primarily the fact that the reference clock or timing pulse generator does not always produce exactly the prescribed reference clock pulse timing. It is thus pertinent to suppress such deviations in the reference clock pulse generation.

For this reason it is advantageous, for such applications, to provide an arrangement for influencing the regulating voltage, particularly that compensates any offset in the signal course or progression at the beginning of a respective second. For example, such a regulating voltage influence or a compensation of any arising offset in the signal course can be realized by software. However, this type of regulating voltage influence or control requires an extremely high computational effort. This can no longer be carried out by the computer processor arrangements present in a radio-controlled clock, because a complete implementation of such regulating voltage influence or control exceeds the capabilities of conventional micro-controllers typically provided for radio-controlled clocks or their receiver circuits. Thus, according to the invention, this computational effort is to be reduced as much as possible.

A further particular advantage of the invention thus exists in providing a simple regulating arrangement for compensating any possibly occurring offset using only previously existing circuit components and the like. In order to compensate an inexact start and thus deviations of the reference clock from a prescribed time marker (for example the second beginning) of the received time signal, the invention provides a compensation circuit that followingly regulates or regulates-out this deviation. Such a regulation operates as follows. If, for example, in a time frame being considered, the actual second beginning occurs earlier than the calculated second beginning, then for determining the second beginning in one of the subsequent time frames at least one clock pulse is skipped (or omitted or not considered), so that the second beginning calculated for this time frame is advanced by the time duration of one clock pulse. On the other hand, if the calculated second beginning comes after the actual second beginning, then an additional clock pulse is inserted for at least one of the subsequent time frames, so that the second beginning calculated for the corresponding time frame is delayed by the duration of one clock pulse or cycle. In this manner, a very simple regulation can be implemented.

The receiver circuit, or the corresponding radio-controlled clock having such a receiver circuit, according to the invention, advantageously have a higher system sensitivity, because interferences at the beginning of a respective time frame are not taken into consideration. Falsifications of the time duration of the amplitude variation can advantageously be avoided by the regulating arrangement described above. Thus, the rate of occurrence of errors due to falsified time durations of an amplitude variation caused by interference pulses is significantly reduced, which ultimately leads to a greater sensitivity of the receiver circuit. The above described purely digital regulation for the compensation of an offset or a deviation in the determination of the second beginning makes external circuit components and tolerance-influenced analog circuit parts superfluous. In this manner, the advantage gained through the above described regulation or compensation is not again eradicated through tolerances of the circuit components. Moreover, the receiver circuit may additionally be relatively simply implemented, because the purely digital regulation can be carried out, for example, by the micro-controller that is present anyway in the radio-controlled clock. The regulation itself requires a relatively small computational effort, so that the other functioning of the micro-controller is only insignificantly impaired by additionally carrying out the regulation.

For determining the second beginning of a time frame, advantageously the time counting by the counter is carried out from the second beginning of the immediately, i.e. directly, preceding time frame. This is especially recommendable in terms of the circuit technology, because the counter in this case can again be reset and newly restarted respectively at the end of each time frame. This makes it possible to use a simple low bit counter.

When a time signal is received for the first time, an actual second beginning is at first not known. However, as described above, in order to determine the second beginning of subsequent time frames according to the invention, an actual second beginning must at first be determined at least one time, and thereafter the subsequent second beginnings of subsequent time frames can be determined, i.e. calculated, according to the invention. For this purpose, the beginning of a first change or variation of the received time signal is at first determined. Then, the duration of a signal amplitude variation is counted-up by the counter. In this regard, the duration of the amplitude variation must be one of only a few possible prescribed durations, and is known from the telegram of the time signal. In this manner, by comparing the detected signal amplitude variation to the known duration, it can be ensured that this first signal amplitude variation is not simply (and falsely) an interference in the time signal. If this has been unambiguously recognized and determined, and a second new amplitude variation of the signal course of the time signal occurs after approximately 1 second following the beginning of the first signal amplitude variation, then the detected beginning of the second new variation is valued or taken (i.e. specified) as a true or actual second beginning. Additionally or alternatively, a method as disclosed in the above mentioned Patent Publications DE 195 14 036 C2 or DE 37 33 965 C2 can be used for determining the first actual second beginning.

Advantageously, the time duration of a time frame is determined by counting the clock pulses of a reference clock signal. This reference clock signal has a known, i.e. prescribed, reference frequency. A clock signal or timing pulse signal with the most constant possible prescribed clock frequency is advantageously used as the reference clock signal or timing pulse signal, which thus has a prescribed number of clock pulses or timing pulses per time frame.

The reference clock signal is preferably a clock signal or timing pulse signal in which the duration of each timing pulse or clock cycle ideally is less than 10% of the duration of the shortest signal amplitude variation prescribed by the telegram of the time signal, i.e. the temporally shortest second marker. Thus, there will be at least ten clock pulses of the reference clock signal during the duration of the shortest signal variation representing a second marker. Ideally and most preferably, the duration of the reference clock cycle amounts to less than 5% of the duration of the shortest time signal variation. For example, if a reference clock signal with a reference frequency of 128 Hz is used (this corresponds to approximately the 1/256^{th} portion or fraction of the frequency of a quartz clock oscillator), and if a time frame amounts to approximately one second, then the counter will have to count-up exactly 128 clock pulses or cycles for determining the timed or calculated second beginning of the next successive time frame. In that regard, a single clock pulse or cycle corresponds to about 7.8 ms.

In the case of the time signal transmitted by the official German time transmitter DCF-77, the changes or variations of the signal amplitude (and particularly the amplitude dips representing second markers) of the time signal have a duration of either 100 ms or 200 ms. Thus, in this case, it must be ensured that the duration of a clock cycle is sufficiently shorter than the shorter signal amplitude variation, i.e. shorter than 100 ms. Namely, if a deviation is detected in the determination of the second beginning, and thus for compensation one clock pulse is skipped or an additional correction pulse is inserted as discussed above, then this skipped or inserted clock pulse may not falsify the decoding and evaluating of the corresponding time information. In the present example case, the skipped clock pulse or the inserted correction pulse with a cycle duration of about 7.8 ms is less than 10% of the 100 ms duration of the signal amplitude variation. Thus, an error on this order of magnitude has essentially no significant influence on the evaluation of the time information. The regulation or compensation of a deviation is nonetheless so fast that such deviations can be sufficiently quickly regulated-out.

The time information exists in a bit-wise manner in the time signal. In that regard, a bit value of a respective data bit is given by a duration of a variation of the amplitude of the transmitted time signal based on the allocated encoding protocol of the time telegram produced by the time signal transmitter. Namely, a binary value derived from the duration of a respective amplitude variation is allocated to each respective associated data bit. In this regard, a first duration of an amplitude variation represents a first logic value of the data bit, while a second duration represents a second logic value of the data bit. These first and second durations are predefined by the encoding protocol of the telegram produced by the time signal transmitter. Typically, the first logic value represents a logic “0” (low signal or low voltage level), while the second logic value represents a logic “1” (high signal or high voltage level). Of course, the opposite logic allocation is also possible.

In most time telegrams of time signals transmitted by typical time signal transmitters, the pertinent variation of the signal amplitude is particularly a reduction or dip of the amplitude of the signal. Nonetheless, it is similarly possible to use the opposite signal variation, namely to provide a binary encoding through temporary peaks or increases of the signal amplitude.

The receiver circuit or a radio-controlled clock including such a receiver circuit according to the present invention simply requires a reference clock signal generator for producing a reference clock or timing pulse signal, a counter that continuously counts-up the timing pulses of the reference clock signal and provides a count value that indicates when the next second beginning must be occurring, as well as an arrangement for determining the respective second beginning by reading-out and evaluating the count value and then determining and indicating the new second beginning after a prescribed number of timing pulses, i.e. a prescribed count value, which ideally corresponds exactly to the duration of a time frame of the time signal.

The functionality of the regulating arrangement and/or the arrangement for determining the second beginning can advantageously be concretely realized in a hard-wired logic circuit. For example, this logic circuit may comprise an FPGA circuit or a PLD circuit. On the other hand, the functionality of these arrangements can alternatively and fundamentally also be satisfied in the micro-controller, for example the four bit micro-controller that is typically present anyway in the radio-controlled clock. The special advantage of the inventive solution using a hard-wired logic circuit is that thereby the determination of the second beginning as well as a regulating voltage influence or compensation can be realized in a very simple manner without burdening the micro-controller in this regard. Thus, the full capabilities of the micro-controller remain available for performing other tasks, for example for decoding and evaluating the time signal, for handling interferences in the time signal, and for carrying out other user-specific tasks.

Preferably, the reference clock signal generator is such a clock signal or timing pulse generator that produces a reference clock or timing pulse signal with a prescribed clock frequency that is as constant as possible. In a very advantageous embodiment, a quartz clock oscillator is provided as the reference clock signal generator.

### BRIEF DESCRIPTION OF THE DRAWINGS

In order that the invention may be clearly understood, it will now be described in connection with example embodiments thereof, with reference to the accompanying drawings, wherein:

FIG. 1 schematically represents the encoding scheme of a time code telegram of encoded time information transmitted by the official German time signal transmitter DCF-77, as conventionally known;

FIG. 2 is a time diagram representing a portion of an amplitude modulated time signal having five second pulses or markers, shown schematically in idealized form without interference, as transmitted by the German time signal transmitter DCF-77;

FIGS. 3A and 3B are schematic time diagrams of a portion of a time signal X and the corresponding clock pulses or timing pulses of a reference clock signal CLK, in connection with which the inventive method for determining the second beginning will be explained;

FIGS. 4A and 4B are schematic time diagrams showing a further portion of a time signal X and the corresponding timing pulses CLK, in connection with which the inventive method for compensating a deviation in the determination of the second beginning will be explained;

FIGS. 5A and 5B are schematic time diagrams showing a further portion of the time signal X and the corresponding timing pulses CLK, in connection with which the inventive method for compensating a deviation in the determination of the second beginning will be explained;

FIGS. 6A and 6B are schematic time diagrams showing a portion of a time signal X and the corresponding timing pulses CLK in connection with which the inventive method for the initial first-time determination of the second beginning will be explained; and

FIG. 7 is a simplified schematic block circuit diagram of a radio-controlled clock including a receiver circuit arrangement for carrying out the inventive method.

### DETAILED DESCRIPTION OF PREFERRED EXAMPLE EMBODIMENTS AND OF THE BEST MODE OF THE INVENTION

In all of the drawing figures, the same elements and signals, as well as the elements and signals respectively having the same functions, are identified by the same reference numbers, unless the contrary is indicated.

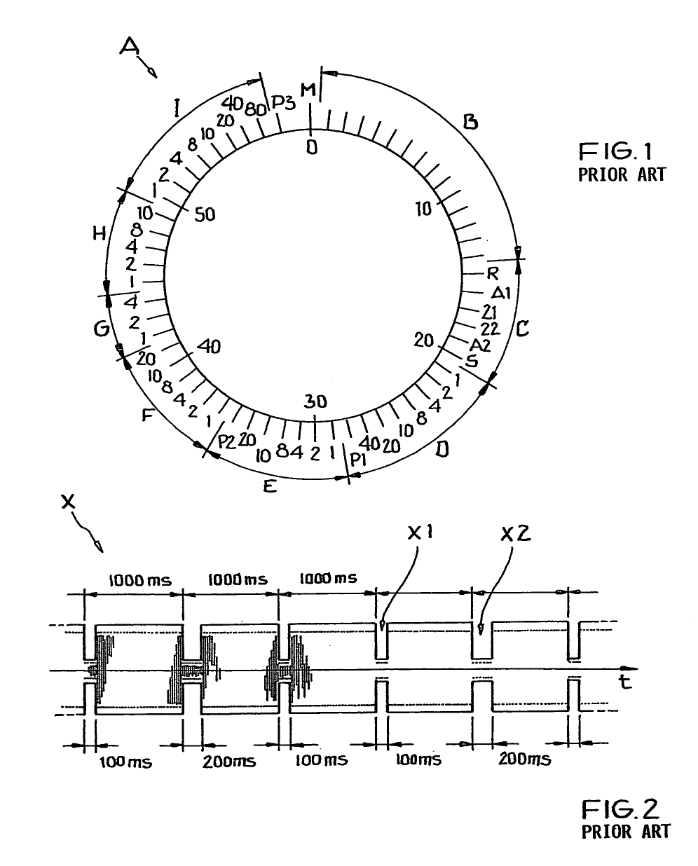

The general format of an encoding scheme or time code telegram A as conventionally known in the time signal transmitted by the German time signal transmitter DCF-77 has been explained above in connection with FIG. 1 in the Background Information section of this specification. Also, the time-variation of the amplitude-modulated time signal is schematically shown in the time diagram of FIG. 2 as discussed above.

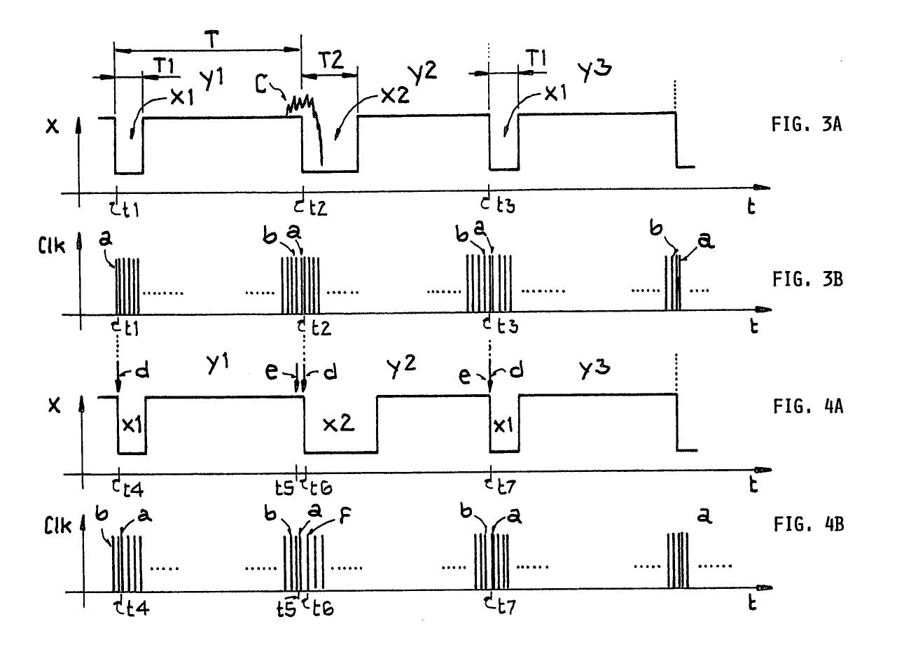

The schematic time diagrams of FIGS. 3A and 3B show a portion of a time signal X and the corresponding timing pulses of a reference clock signal CLK in connection with which the inventive method for determining the second beginning will now be explained. As an example, FIG. 3A shows the time signal X transmitted by the German time signal transmitter DCF-77. Particularly, the portion of the time signal X shown in FIG. 3A includes three complete time frames Y1, Y2, and Y3. The duration of each of the time frames Y1 to Y3 respectively amounts to T=1000 ms or 1 sec. It should be noted that the example illustrated in FIG. 3A is not intended or suitable for representing a particular or special encoding of an actual time information, but instead is presented as a simple generic example of representative features of the signal. Also note, for the sake of clarity, the time scale has been rather drawn out or extended.

The time signal X transmitted by the German time signal transmitter DCF-77 includes two different second markers represented by different amplitude dips for carrying out the binary encoding of the transmitted time information. The first amplitude dip X1 has the duration T1=100 ms, while the second amplitude dip X2 has the duration T2=200 ms. The first dips X1 correspond to the binary “0” (low) while the second dips X2 correspond to the binary “1” (high). In this regard, the binary “1” and “0” respectively correspond to a data bit.

For the present discussion, it is initially assumed that a known second beginning (i.e. a known beginning time point of a second marker X1) is present at the time point t1. At this time point t1, a counter that is timed and incremented by a reference frequency begins to continuously count-up the timing pulses of the reference clock signal CLK as shown in FIG. 3B. The reference character “a” identifies the respective first timing pulse at the respective beginning of counting-up of the counter. The reference clock signal CLK has a constant reference frequency of 128 timing pulses per second. In the present example, in which the time frame Y1 has a duration T=1000 ms, the counter must thus count up exactly 128 timing pulses during the entire time frame Y1. Once the counter arrives at the 128^{th} timing pulse “b”, then a signal is emitted, which indicates that the next subsequent second beginning of the next following time frame Y2 will occur at the next timing pulse “a” at the time point t2. Namely, at that time point t2, the counter will be reset and will again start to count up beginning with a new first timing pulse “a”. This is the case regardless whether the time signal X is superimposed with and potentially falsified by an interference signal “c” at the time point t2 as shown in FIG. 3A.

In a similar manner as discussed above for the initial second beginning at the time point t1, the new second beginning at the time point t2 is again used as a reference for determining the next following second beginning of the next following time frame Y3 at the time point t3. For this purpose, the count value of the counter is reset at the time point t2, so that the counter thereafter again is continuously incremented anew. Namely, from the time point t2, the counter will again count up beginning with the first new timing pulse “a”. This is a very simple and elegant manner of determining or acquiring the second beginning for each successive time frame Y1 to Y3 from the second beginning of each respective preceding time frame Y1 to Y3, through simple incremental counting of a known constant reference clock signal CLK.

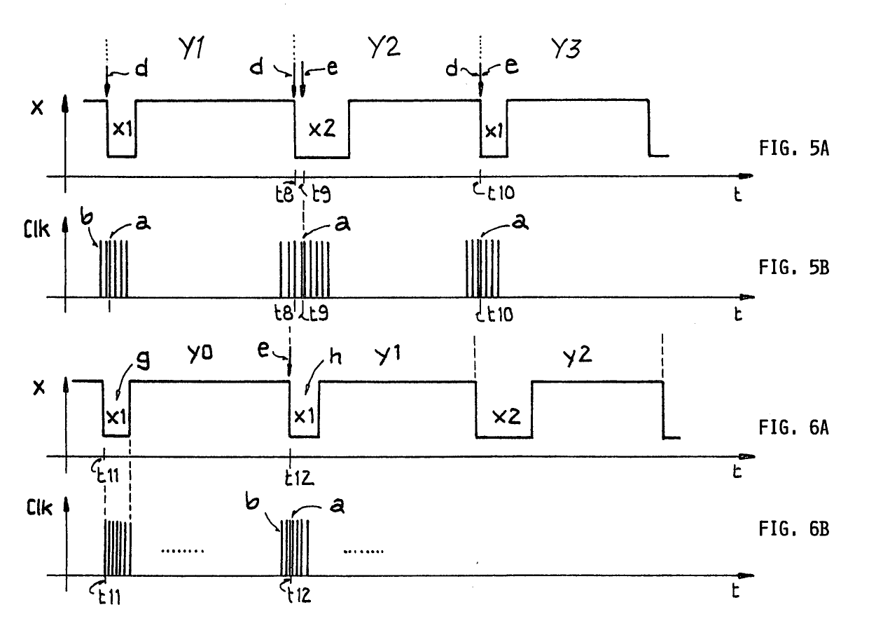

However, it is problematic that deviations can arise in the determination of the second beginning, for example due to reception interferences, or simply because the duration T of one time frame does not correspond exactly to an integer number of the reference timing pulses of the clock signal CLK. FIGS. 4A and 4B show a further portion of a time signal, in connection with which the inventive method for compensating such a deviation in the determination of the second beginning will now be explained.

In FIG. 4A, the arrow “d” indicates the actual second beginning, while arrow “e” indicates the second beginning that has been calculated or determined according to the invention. Note that the calculated second beginning “e” at time point t5 is time shifted or offset from the actual second beginning “d” at time point t6. In this regard, the calculated second beginning “e” has been determined by the counter simply counting up timing pulses from the actual second beginning “d” of the first time frame Y1 at the time point t4 until reaching the prescribed count for the new second beginning “e” at the time point t5 for the next subsequent time frame Y2. At this point, the counter is reset. However, as mentioned, the actual new second beginning “d” for the time frame Y2 actually occurs at the later time point t6, i.e. later than the calculated second beginning “e”.

When the actual new second beginning “d” at the time point t6 can be unambiguously detected, and thus the time-offset of the calculated second beginning “e” can be determined, the inventive method calls for inserting an additional timing pulse “f” in the counting of the counter for determining the next new second beginning “e” of the next subsequent time frame Y3. In this manner, the counter determines or calculates the next new second beginning “e” at the correct (or at least a better approximation of the) actual time, i.e. (at least more closely) coinciding with the actual next second beginning “d” of the next subsequent time frame Y3 at the time point t7. The accuracy is limited to the closest timing pulse.

Typically, the above described compensation of a deviation or time-offset between the actual and the calculated second beginning “d”, “e” is not necessarily carried out within the duration of a single time frame. Rather, it will typically be necessary to allow several successive time frames for carrying out the compensation. Nonetheless, the regulation or compensation is still carried out so quickly that any arising deviations are sufficiently quickly regulated-out to avoid causing any defects or problems in the decoding of the second markers X1, X2.

FIGS. 5A and 5B show a further portion of the time signal X and the associated timing pulses of the reference clock signal CLK, in connection with which the inventive method for the compensation of a deviation will now be explained. In comparison to the example in FIGS. 4A and 4B, the new calculated second beginning “e” for the time frame Y2 at the time point t9 lags behind, i.e. falls at a time after, the actual new second beginning “d” of this time frame Y2 at the time point t8. In this case, the compensation involves skipping or omitting a single timing pulse, in this example embodiment the first timing pulse “a”, in the counting of the reference clock signal CLK by the counter. This is schematically represented in FIG. 5B by crossing out or lining-out this timing pulse “a”.

FIGS. 6A and 6B schematically show a further portion of the time signal X as well as the associated timing pulses of the reference clock signal CLK, in connection with which the inventive method for the initial determination of the second beginning will now be explained. Namely, the first-time or initial determination of an actual second beginning according to the invention is based on and further developed from the following general recognition. The second markers X1, X2 of the transmitted and received time signal X have respective exactly defined and known time durations of the signal amplitude depressions or dips X1 and X2 representing these second markers. Namely, in this example, the duration of each amplitude dip X1, X2 can amount to either 100 ms or 200 ms. If a respective detected amplitude dip has a longer or shorter duration, then one can conclude that an interference exists, so that it is not possible to unambiguously detect a second marker and particularly a second beginning of a second marker. Thus, for carrying out the first-time or initial determination of a second beginning, it is necessary to achieve an unambiguous detection and identification of such an amplitude dip X1 or X2.

The inventive method now is further based on using the reference clock signal CLK with a known reference frequency for identifying the amplitude dips X1, X2. In other words, each amplitude dip X1, X2 having a duration T1, T2 must correspond with a known prescribed number of reference timing pulses, whereby the respective number of pulses is derived from the reference frequency of the reference clock signal CLK relative to the duration of the amplitude dip. If the counter counts the proper number of reference timing pulses corresponding to the prescribed first duration T1 or the prescribed second duration T2 during a detected amplitude dip X1, X2, then this indicates that a valid second marker X1 or X2 has been properly received and detected. The detected beginning of the detected amplitude dip “g” at time t11 in the time frame Y0 is taken as a fixed actual second beginning as a reference for determining the subsequent second beginning of the next following time frame Y1, as follows.

Namely, from this detected actual second beginning at time t11, the counter counts continuously upwardly, until it reaches the number of reference pulses corresponding to the known duration T of a time frame Y1 to Y3. At that point, as mentioned above, an output signal indicates that a calculated second beginning will occur with the next timing pulse. Also, if at this time a new amplitude dip or reduction “h” in the amplitude of the received time signal X is detected unambiguously as described above, then the detected beginning of this new amplitude dip “h” at actual time t12 can be taken as a new actual second marker. This new actual second marker can then be used as a reference for counting or calculating the next subsequent second beginning according to the above described inventive method, in that the counter is reset and then begins to count up from the second beginning “e” for the time frame Y1 at the time point t12. This process can be repeated from time frame to time frame, whereby either the actual detected second beginning (if unambiguously detected) or the calculated second beginning is used as the basis for calculating the next second beginning, depending on whether the respective amplitude dip beginning at the calculated second beginning can be unambiguously detected. The pertinent second beginning for each respective time frame is then used as a reference for decoding and evaluating the time information encoded in that time frame.

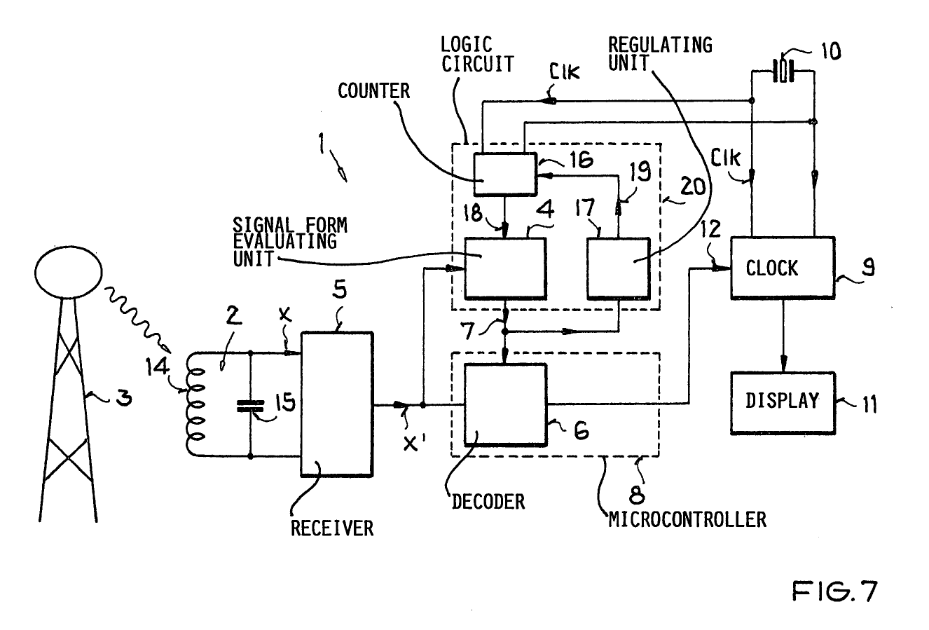

FIG. 7 is a schematic block circuit diagram of a strongly or sharply simplified radio-controlled clock for carrying out the inventive method. The radio-controlled clock 1 comprises one or more antennas 2 for receiving a time signal X transmitted by a time signal transmitter 3. In the present example embodiment, the antenna 2 comprises a coil 14 with a ferrite core, and a capacitive element 15, for example a capacitance or concretely a capacitor 15, connected parallel to the coil 14. A receiver circuit 5 for receiving the time signal X received by the antenna 2 is connected after or downstream from the antenna 2. The receiver circuit 5 typically comprises one or more filters, for example a bandpass filter, a rectifier circuit, and an amplifier circuit, for filtering, rectifying and amplifying the received time signal X to produce a corresponding received, filtered, rectified and amplified time signal X′. The particular construction and operation of such a receiver circuit 5 can be embodied according to any conventionally known teachings, for example as set forth in the above mentioned prior art reference documents.

For determining the second beginning, the inventive circuit arrangement of the radio-controlled clock 1 further comprises a signal form evaluating arrangement or unit 4 connected after or downstream from the receiver circuit 5 to receive the received, filtered, rectified and amplified time signal X′, from which it determines a second beginning, which is output in a corresponding control signal 7 at an output of the signal form evaluating arrangement 4. More particularly, the arrangement or unit 4 is adapted to carry out at least one of the inventive methods described above in connection with FIGS. 3 to 6.

The circuit arrangement further comprises an incrementing counter 16 connected to the signal form evaluating arrangement 4, and a reference clock signal generator 10 that provides a reference clock signal CLK to the counter 16 for triggering the same. In the present example embodiment, the reference clock signal generator 10 advantageously comprises a quartz clock oscillator 10. The counter 16 continuously counts up the timing pulses of the reference clock signal CLK, while being cyclically reset as described above. The actual presently existing count value of the counter 16 is provided as a count value signal 18 at an output of the counter 16. This count value signal 18 is provided to an input of the signal form evaluating arrangement 4 to be used in the inventive method carried out in the arrangement 4 as described above.

The control signal 7 output by the signal form evaluating arrangement 4, which indicates each successive second beginning, is provided to an input of a regulating arrangement or unit 17. Based on the control signal 7, the regulating arrangement 17 produces a control signal 19 that is provided to an input of the counter 16. In response to and dependent on the control signal 19, the counter 16, as needed, counts an additional inserted timing pulse or skips over a timing pulse of the reference clock signal CLK, in order to compensate a time-offset or shifting of the calculated second beginning “e” relative to the actual second beginning “d”, as described above.

The circuit arrangement further includes a decoding arrangement or unit 6 connected after or downstream of the receiver circuit 5 so as to receive and decode the amplified time signal X′. The decoding arrangement 6 is similarly controlled by the control signal 7 output by the signal form evaluating arrangement 4. The decoding arrangement 6 can have any conventionally known construction and operation.

The decoding arrangement 6 can be a component of the receiver circuit 5, or it can be a separate component provided in the radio-controlled clock 1. In the present example embodiment, the decoding arrangement 6 is a component of a program-controlled arrangement 8, which may typically be embodied as a micro-controller, which is typically a four bit micro-controller in a radio-controlled clock circuit. This micro-controller 8 is designed and adapted to receive the sequence of data bits produced by the decoding arrangement 6 from the signal X′ provided by the receiver circuit 5, and to calculate therefrom an exact clock time and/or an exact date. The micro-controller 8 then produces and outputs a clock time and date signal 12 based on and indicating the thusly calculated clock time and date.

The signal form evaluating arrangement 4, the counter 16, and/or the regulating arrangement 17 can be respective portions or components of a logic circuit 20, and especially a hard-wired logic circuit 20. Through such provision of a logic circuit 20 embodying and incorporating the components 4, 16 and 17, the micro-controller 8 is relieved of additional functional burden, so that its entire processing capacity remains available for carrying out other tasks.

The radio-controlled clock 1 further comprises a local electronic clock 9, of which a local clock time is controlled by the quartz clock oscillator 10. The electronic clock 9 is connected to an indicator 11, for example a visual display 11, which indicates, e.g. visually displays, the clock time and/or the date. The local electronic clock 9 further receives the clock time and date signal 12, and accordingly corrects or synchronizes the displayed time with the time information provided in the time signal X.

Although the invention has been described and illustrated above in connection with preferred example embodiments thereof, the invention is not limited to these disclosed embodiments, but rather is modifiable to cover a great variety and number of different embodiments. For example, the invention is not limited to the particular numerical values or ranges disclosed herein as examples. To the contrary, the scope of the invention also covers variations or changes of numerical values and ranges as would be understood by a person of ordinary skill in the art upon considering the present disclosure.

In the above described example embodiments, the time encoding was realized by temporary dips or reductions of the signal amplitude of the carrier signal at the respective beginning of respective time frames. It should be understood that the encoding could alternatively be realized by temporary increases or any other variation of the signal amplitude of the carrier signal in the respective time frames. Also, other types of signal modulation could alternatively be used.

While the above discussion has especially related to a radio-controlled clock receiving the time signal via a wireless radio transmission through an antenna, the present invention also relates to a method and clock apparatus receiving a time signal via a hard-wired transmission. For example, systems including several clocks that are to be synchronized with one another and that are connected to each other by a time signal wire for this purpose, can also be embodied according to the present invention, and are covered within the scope of the appended claims. Such clocks may generally be regarded as remote-controlled clocks, but are also to be understood within the term radio-controlled clocks.

The illustrated and explained example embodiment of a receiver circuit is merely one possible example of a concrete circuit for embodying an inventive receiver circuit and radio-controlled clock. This example embodiment can readily be varied by exchanging individual or simple circuit components or entire functional blocks or units, as would be understood by a person of ordinary skill in the art upon considering this disclosure.

The term “sufficient accuracy” herein means any pre-specified range of accuracy sufficient to make the determination at issue; e.g. an accuracy within +/−1 timing pulse when timing durations of signal features by counting the timing pulses, or some other pre-selected accuracy.

Although the invention has been described with reference to specific example embodiments, it will be appreciated that it is intended to cover all modifications and equivalents within the scope of the appended claims. It should also be understood that the present disclosure includes all possible combinations of any individual features recited in any of the appended claims.

1. A method of processing a transmitted time signal, comprising the steps:
a) receiving a time signal that has been transmitted from a time signal transmitter, wherein said time signal comprises a succession of time frames that each respectively have a constant duration and that encode time information, and wherein respective amplitude variations of an amplitude of said time signal indicate respective actual second beginnings of respective second markers of said time information respectively within said time frames;
b) providing a reference clock signal comprising a succession of reference timing pulses;
c) obtaining a known actual second beginning among said actual second beginnings, for a given time frame among said time frames; and
d) determining a calculated second beginning for a subsequent time frame among said time frames temporally following said given time frame by counting a prescribed number of said reference timing pulses of said reference clock signal starting from said known actual second beginning.

2. The method according to claim 1, wherein a time duration represented by said prescribed number of said reference timing pulses corresponds at least approximately to said constant duration of said time frames with an accuracy giving an error of no more than +/−1 of said reference timing pulses.

3. The method according to claim 1, wherein said step c) of obtaining said known actual second beginning comprises the sub-steps:
c1) determining at least one valid duration of said amplitude variations in accordance with an encoding protocol of said time information encoded in said time signal;
c2) detecting a first said amplitude variation in said given time frame, including detecting an apparent beginning of said first amplitude variation;
c3) determining a measured duration of said first amplitude variation by counting said reference timing pulses starting at said apparent beginning and continuing throughout said first amplitude variation; and
c4) if said measured duration matches with sufficient accuracy at least one said valid duration, then specifying said apparent beginning as said known actual second beginning.

4. The method according to claim 3, wherein said step c) of obtaining said known actual second beginning further comprises the sub-step:
c5) if said measured duration does not match with sufficient accuracy at least one said valid duration, then successively repeating said sub-steps C2), C3), C4) and C5) in successive cycles for successive ones of said time frames respectively as said given time frame until said measured duration matches at least one said valid duration and then specifying said apparent beginning as said known actual second beginning.

5. The method according to claim 3, further comprising the steps:
e) detecting another said amplitude variation in said subsequent time frame, including detecting another apparent beginning of said another amplitude variation;
f) if said another apparent beginning of said another amplitude variation matches with sufficient accuracy said calculated second beginning, then specifying said another apparent beginning as an actual second beginning of said subsequent time frame.

6. The method according to claim 5, wherein said step f) further comprises resetting and restarting said counting of said prescribed number of said reference timing pulses starting from said actual second beginning of said subsequent time frame to determine a next calculated second beginning for a further subsequent time frame temporally following said subsequent time frame, and then repeating said steps e) and f) for said further subsequent time frame.

7. The method according to claim 5, further comprising the step:
g) if said another apparent beginning of said another amplitude variation does not match with sufficient accuracy said calculated second beginning, then using said calculated second beginning as a substitute beginning of said second marker of said subsequent time frame.

8. The method according to claim 7, wherein said step g) further comprises resetting and restarting said counting of said prescribed number of said reference timing pulses starting from said substitute beginning of said subsequent time frame to determining a next calculated second beginning for a further subsequent time frame temporally following said subsequent time frame, and then repeating said steps e), f) and g) for said further subsequent time frame.

9. The method according to claim 1, wherein said reference clock signal has a known reference frequency of said reference timing pulses, and further comprising determining said constant duration of said time frames by counting said reference time pulses during one of said time frames.

10. The method according to claim 1, wherein said reference clock signal has a prescribed constant reference frequency of said reference timing pulses and a prescribed certain number of said reference timing pulses per said constant duration of each one of said time frames.

11. The method according to claim 10, wherein said reference clock signal has a pulse period from one to a next of said reference timing pulses that is less than 10% of a duration of a shortest one of said amplitude variations.

12. The method according to claim 10, wherein said reference clock signal has a pulse period from one to a next of said reference timing pulses that is less than 5% of a duration of a shortest one of said amplitude variations.

13. The method according to claim 1, wherein said subsequent time frame is an immediately next time frame that immediately and directly follows said given time frame.

14. The method according to claim 1, further comprising the steps:
e) detecting an actual beginning of a first said amplitude variation in said subsequent time frame;
f) comparing said actual beginning with said calculated second beginning to determine any deviation therebetween;
g) if said deviation exists and exceeds a threshold, then performing a compensation adjustment in determining a next calculated second beginning for a further subsequent time frame temporally following said subsequent time frame.

15. The method according to claim 14, wherein, if said calculated second beginning comes temporally before said actual beginning, then said compensation adjustment in said step g) comprises adding at least another one of said reference timing pulses to said prescribed number of said reference timing pulses that are to be counted for determining said next calculated second beginning for said further subsequent time frame.

16. The method according to claim 14, wherein, if said calculated second beginning comes temporally after said actual beginning, then said compensation adjustment in said step g) comprises subtracting, skipping or not considering at least one of said reference timing pulses from said prescribed number of said reference timing pulses that are to be counted for determining said next calculated second beginning for said further subsequent time frame.

17. The method according to claim 1, further comprising decoding and evaluating said time information with reference to at least one of said known actual second beginning and said calculated second beginning so as to determine from said time information at least one of an actual clock time and an actual date.

18. The method according to claim 1, wherein said time information is encoded bit-wise in said time frames with at least one data bit respectively encoded in each one of said time frames, a logic value of each one of said data bits is determined by a respective duration of a respective one of said amplitude variations corresponding to said respective data bit, a first said logic value is allocated to a first said duration, and a second said logic value is allocated to a second said duration.

19. The method according to claim 18, wherein said first logic value is a logic zero and said second logic value is a logic one.

20. The method according to claim 18, wherein said variation of said amplitude is a temporary reduction of said amplitude of said time signal.

21. A circuit arrangement for a radio-controlled clock for receiving and acquiring time information from a time signal that is transmitted by a time signal transmitter and that has said time information encoded in successive time frames therein, said circuit arrangement comprising:
a receiver unit adapted to receive said time signal; and
a time synchronization circuit connected to an output of said receiver circuit and adapted to determine a beginning of a second in one of said time frames by counting reference timing pulses of a reference clock signal starting from an already known second beginning of a previous one of said time frames.

22. The circuit arrangement according to claim 21, wherein said time synchronization circuit comprises a signal form evaluating arrangement adapted to evaluate a signal form of said time signal.

23. The circuit arrangement according to claim 21, wherein said time synchronization circuit comprises a reference clock signal generator adapted to generate said reference clock signal, and a counter connected to said reference clock signal generator to receive said reference clock signal, wherein said counter is adapted to count-up said reference timing pulses of said reference clock signal and to reset and restart counting upon reaching a prescribed count value.

24. The circuit arrangement according to claim 23, wherein said reference clock signal generator comprises a quartz clock oscillator adapted to generate said reference clock signal with a prescribed constant frequency of said reference timing pulses.

25. The circuit arrangement according to claim 21, wherein said time synchronization circuit comprises a regulating unit adapted to detect and compensate any deviation between said beginning of said second determined by said counting of said reference timing pulses and an actual second beginning of said second in said one of said time frames.

26. The circuit arrangement according to claim 21, wherein said time synchronization circuit comprises a hard-wired logic circuit incorporating therein at least one of: a regulating unit adapted to detect and compensate any deviation between said beginning of said second determined by said counting of said reference timing pulses and an actual second beginning of said second in said one of said time frames; a counter adapted to count said reference timing pulses; and a signal form evaluating arrangement adapted to evaluate a signal form of said time signal.
